(19) United States
(12) Patent Application Publication
(10) Pub. No.: US 2005/0006873 A1
(43) Pub. Date: Jan. 13, 2005

(54) Rear fork end component, bicycle frame and bicycle

(76) Inventors: Yutaka Kaburagi, Kanagawa (JP); Takeo Sunami, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/887,929

(22) Filed: Jul. 12, 2004

(30) Foreign Application Priority Data
Jul. 11, 2003 (JP) 2003-273417

(51) Int. Cl. B62K 5/00

(52) U.S. Cl. 280/288

(57) ABSTRACT

A rear fork end component 34a on a rear derailleur (32) side of a bicycle frame (4) comprises, when assuming a bicycle frame (4) produced by using the end component (34a), a component body 341a; a first concave portion 342 formed on the component body 341a, for detachably supporting an axle (362) of a rear wheel (36) to be inserted from below the frame; a first protrusion 344 formed to protrude from a frame front side inner wall 344a of the first concave portion 342 to the frame front side, having at its end a second concave portion 344c as a chain stay attachment portion for allowing a rear end of a chain stay 54a to be attached; a second protrusion 346 formed to protrude from a frame rear side inner wall surface of said first concave portion 342 to the frame lower side, having a first female screw 346d for fitting with a male screw (327) for attaching the rear derailleur (32); a third protrusion 348 formed to protrude from a frame upper outer surface 344b of the first protrusion 344 and a frame rear side outer surface 346d of the second protrusion 346, having near the frame front side of its end a third concave portion 348c as a seat stay attachment portion for allowing a rear end of the seat stay 52a to be attached; wherein the third concave portion 348c is arranged to be offset from the first concave portion 342 to the frame upper side and frame rear side. According to a bicycle using the component 34a, it is not necessary to attach an end clasp to an end portion after removing the rear wheel when putting the bicycle in a wheeling bag.

### BACKGROUND OF THE INVENTION

1. Field of the Invention

The present invention relates to a rear fork end component of a bicycle frame, a bicycle frame having the component and a bicycle having the frame.

2. Description of the Related Art

Conventionally, a rear end fork component attached on the rear derailleur side of a bicycle frame generally has a “dogleg” shape. The upper end of the dogleg shape is attached with a rear end of a seat stay, the lower end thereof is attached with a rear end of a chain stay, near the bent portion of the dogleg shape is provided with a rear wheel axle supporting portion for detachably supporting the axle of the rear wheel, and a protrusion for attaching the rear derailleur is formed to extend downward from the bent portion toward the frame lower aide. Namely, a conventional rear fork end component is arranged so that the attaching position of the rear end of the seat stay is offset to the frame upper side and the frame front side.

To enjoy touring or cycling in a remote place with one's own bicycle, other than a method of carrying the bicycle by a vehicle to the place, there are a method of using a wheeling bag for putting in the bicycle and carrying by various transportations, such as a train, bus, airplane and ferry, to the place, and a method of using package service to send it to the place. When using a wheeling bag, the bicycle is again put in the wheeling bag and carried back by his/her own or sent back by using package service after enjoying the touring or cycling.

When putting the bicycle in the wheeling bag, the front and rear wheels are removed in some cases other than the ease of not removing the front and rear wheels and the case of removing only the front wheel. In the case of a type of removing the both, the bicycle can be most compactly packed comparing with the other two cases. Therefore, compact and light wheeling bags for this type are widely used.

When preparing for conveying a bicycle having a conventional bicycle frame as explained above, after removing a rear wheel from a rear fork end portion, a protector clasp called an end clasp is attached to the end portion. The reason why the clasp is attached to the end portion is to prevent troubles that a rear derailleur is damaged and a gearshift wire of the derailleur is bent, etc. on the way of conveying the bicycle. Accordingly, normally, after attaching the end clasp to the end portion, the frame is put in the wheeling bag spread on the ground in a state that a saddle thereof and the end clasp portion face downward to the ground.

However, when putting into the wheeling bag, the task of attaching the end clasp to the end portion after removing the rear wheel is one of troublesome tasks for the user and has been desired to be improved.

### SUMMARY OF THE INVENTION

An object of the present invention is to provide a rear fork end component of a bicycle frame not requiring attachment of the end clasp, a bicycle frame having the component, and a bicycle having the frame.

First Aspect

To attain the above object, according to a first aspect, there is provided a rear fork end component of a bicycle frame, comprising:

when assuming a bicycle frame produced by using the end component,

a component body;

a rear wheel axle supporting portion formed on the component body, for detachably supporting the axle of the rear wheel to be inserted from below the frame; and

a seat stay attachment portion for allowing a rear end of a seat stay to be attached;

wherein said seat stay attachment portion is arranged to be offset from said rear wheel axle supporting portion to the upper side of the frame and the rear side of the frame (hereinafter, also expressed as “a back offset seat stay).

When using the component according to the first aspect, a bicycle frame wherein a position of attaching the seat stay is arranged to be offset from the rear wheel axle supporting portion to the frame upper side and frame rear side can be produced. When setting up necessary components to the bicycle frame, a bicycle wherein a position of attaching a rear and of the seat stay is arranged to be offset from the rear wheel axle supporting portion to the frame upper side and frame lower side can be assembled.

According to the first aspect, a bicycle frame having the rear fork end component is provided. According to the first aspect, a bicycle having the bicycle frame is provided.

According to the first aspect, by suitably adjusting the above offset amount,

at the time of conveying the bicycle,

(1) Even when an end clasp is not attached to the end portion of the frame (hereinafter, meaning “a portion incorporating the rear fork end component of the bicycle frame”) after removing the rear wheel and the bicycle is placed on the ground with the saddle and the end portion face downward, a part of the rear derailleur can be prevented from touching the ground.

(2) The gearshift wire of the rear derailleur can be prevented from being pulled to the frame upper side. As a result, the bicycle after removing the rear wheel can stably stand by itself on the ground.

Also, when suitably adjusting the offset amount, preventing the gearshift wire of the rear derailleur from being pulled to the frame upper side, and letting the bicycle after removing the rear wheel stand by itself on the ground, the gearshift wire is not pressed to recede by the ground and troubles that the gearshift wire is bent, etc. can be prevented.

Namely, a bicycle frame having the component according to the first aspect and a bicycle having the frame are advantageous when enjoying cycling by conveying the bicycle. Furthermore, the bicycle can stably stand by itself after removing the rear wheel, so that it is also advantageous for maintenance and storage other than conveying.

Also, the gearshift wire of the rear derailleur which conventionally had to set outside the frame (particularly, the seat stay or the chain stay) can be set inside the frame (particularly, the seat stay) in the present invention. It is because a back offset seat stay is applied and a distance between the seat stay and the rear wheel axle can be secured relatively long comparing with that in the conventional frame, so that the risk of interference between the wire and the sprocket is low even when the gearshift wire is set inside the frame. As a result, the gearshift wire protrudes less to the outer side in the frame width direction. Consequently, the possibility that branches and grasses, etc. get tangled in the gearshift wire while cycling decreases and a gearshift trouble is suppressed.

In the bicycle frame and the bicycle according to the first aspect, the component according to the first aspect may be

A) applied only to the rear fork end component of the rear derailleur side (normally on the right side when facing to the bicycle moving direction), or

B) applied only to the rear fork end component on the opposite side of the rear derailleur (normally, on the left side when facing to the bicycle moving direction)

in the bicycle frame.

Note that it is the most preferable to apply to both rear fork end components on the rear derailleur side and on the opposite side thereof.

In the bicycle frame and the bicycle according to the first aspect, the component according to the first aspect in the bicycle frame is preferably as below.

A) When applying to the rear fork end component on the rear derailleur side, the rear fork end component preferably has the configuration of a second aspect below.

B) When applying to the rear fork end component on the opposite side of the rear derailleur, the configuration of a third aspect below is preferably applied.

Second Aspect

According to the second aspect, there is provided

a rear fork end component on the rear derailleur side of a bicycle frame comprising, when assuming a bicycle frame produced by using the end component:
a component body;
a rear wheel axle supporting portion formed on the component body, for detachably supporting the axle of the rear wheel to be inserted from below the frame;
a first protrusion formed to protrude from a frame front side inner wall surface of the rear wheel axle supporting portion to the frame front side, having at its end a chain stay attachment portion for allowing a rear end of a chain stay to be attached;
a second protrusion formed to protrude from a frame rear side inner wall surface of said rear wheel axle supporting portion to the frame lower side, having near its and a first female screw capable of fitting with a male screw for attaching the rear derailleur; and
a third protrusion formed to protrude from a frame upper side outer surface of said first protrusion and a frame rear side outer surface of said second protrusion to the frame upper side and the frame rear side, having near the frame front side of its end a seat stay attachment portion for allowing a rear end of the seat stay to be attached;
wherein said seat stay attachment portion is arranged to be offset to the frame upper side and the frame rear side from said rear wheel axle supporting portion.

When using the component according to the second aspect, a bicycle frame wherein a position of attaching the rear end of the seat stay is arranged to be offset from the rear wheel axle supporting portion to the frame upper side and frame rear side can be produced. When necessary components are set up to the bicycle frame, a bicycle wherein a position of attaching the rear end of the seat stay is arranged to be offset from the rear wheel axle supporting portion to the frame upper side and frame rear side can be assembled.

According to the second aspect, a bicycle frame having the above rear fork end component is provided. According to the second aspect, a bicycle having the above bicycle frame is provided.

Note that in the second aspect, the rear fork end component on the opposite side of the rear derailleur of the bicycle frame is not particularly limited and may be a type provided with a disc brake base or a type without it (for example, a rim brake type).

According to the second aspect, by suitably adjusting the above offset amount, the same effects as those in the above first aspect can be obtained when preparing for conveying the bicycle.

In the component according to the second aspect, said seat stay attachment portion is preferably arranged at a position where the protruding direction of said third protrusion and the extending direction of the seat stay are at an approximately right angle to each other.

In the component according to the second aspect, preferably, a second female screw capable of fitting with a male screw for attaching a back rack is formed on the frame rear side of said seat stay attachment portion of said third protrusion. When using the rear fork end component formed with the second screw as such, a bicycle frame capable of attaching a back rack to the frame rear portion and a bicycle having the frame can be provided. Particularly, since a bicycle having the bicycle frame wherein the above back offset seat stay is applied is capable of setting the gearshift wire of the rear derailleur inside the frame (particularly, seat stay), even when attaching the back rack on the rear portion of the bicycle, the back rack on the rear portion and the gearshift wire hardly interfere with each other and the back rack on the rear portion can be sleekly attached.

Third Aspect

According to a third aspect, there is provided a rear fork end component on the opposite side of the rear derailleur of the bicycle frame comprising, when assuming a bicycle frame produced by using the end component:

a component body;

a rear wheel axle supporting portion formed on the component body, for detachably supporting the axle of the rear wheel to be inserted from below the frame;

a first′ protrusion formed to protrude from the frame front side inner wall of the rear wheel axle supporting portion to the frame front side, having at its end a chain stay attachment portion for allowing a rear end of a chain stay to attach;

a second′ protrusion formed to protrude from the frame upper side inner wall surface of said first′ protrusion to the frame front side and the frame upper side, having a pair of through holes for fixing a disc brake caliper from a back surface; and

a third′ protrusion formed to protrude from a frame upper side outer surface of the second′ protrusion to the frame upper side and frame rear side, having near the frame front side of its end a seat stay attachment portion for allowing a rear end of a seat stay to be attached;

wherein said seat stay attachment portion is arranged to be offset to the frame upper side and frame rear side from said rear wheel axle supporting portion.

Preferably, said pair of through holes are arranged to satisfy the international standard (a through hole width of 51 mm).

When using the component according to the third aspect, a bicycle frame wherein a position of attaching the rear end of the seat stay is arranged to be offset from the rear wheel axle supporting portion to the frame upper side and frame rear side, and a disc brake base (preferably a disc brake base of the international standard) is formed not on the upper side of the end portion (on the side of attaching the rear end of the seat stay) but inside the end portion (on the side of attaching the rear end of the chain stay) can be produced. When setting up necessary components to the bicycle frame, a bicycle wherein a position of attaching the rear end of the seat stay is arranged to be offset from the rear wheel axle supporting portion to the frame upper side and frame rear side, and the disc brake caliper is attached inside the end portion can be assembled.

According to the third aspect, a bicycle frame having the above rear fork end component is provided. According to the third aspect, a bicycle having the above bicycle frame is provided.

In the third aspect, in the same way as in the first and second aspects, it is easy to make the bicycle after removing the rear wheel stably stand by itself on the ground.

In addition to the above, since the inside base is applied in the third aspect, a disc brake base is formed on the first′ protrusion for allowing to be attached with a chain stay having higher strength and rigidity than those in the seat stay. Namely, the disc brake base is formed on the more sturdy chain stay side. Therefore, when comparing with the conventional configuration wherein the disc brake base is formed on the third′ protrusion for allowing to be attached with a seat stay having lower strength and rigidity, there is no need to furthermore weld a reinforcing plate or to make the seat stay thick, moreover, a howling noise made by braking can be suppressed.

Also, due to the inside base, the disc brake caliper can be fit between the seat stay and the chain stay. As a result, the risk of damaging the caliper due to toppling, etc. is decreased.

Furthermore, since the back offset seat stay is applied, a distance between the seat stay and the chain stay can be made longer comparing with that in the conventional frame. As a result, a disc brake having any shape and any dimensions can be applied.

Furthermore, due to the inside base, the attached disc brake caliper after is not arranged to protrude to the frame upper side. As a result, the bicycle after removing the rear wheel for conveying can more stably stand by itself on the ground.

In the component according to the third aspect, preferably, said seat stay attachment portion is arranged at a position where the protruding direction of said third′ protrusion and the extending direction of the seat stay are at an approximately right angle to each other. When using the rear for end component wherein the seat stay attachment portion is arranged as above, a bicycle frame wherein the protruding direction of said third′ protrusion and the extending direction of the seat stay are at an approximately right angle to each other can be produced. When necessary components are set up to the bicycle frame, a bicycle wherein the protruding direction of said third′ protrusion and the extending direction of the seat stay are at an approximately right angle to each other can be assembled.

When putting brake on the rear wheel in the bicycle provided with the disc brake devices on the front and the rear, a force of rotating together with the wheel about the axle of the rear wheel is imposed on the end portion. However, as explained above, in the case where the protruding direction of said third′ protrusion and the extending direction of the seat stay are at an approximately right angle to each other, a force is imposed only in the direction of compressing the seat stay, rear fork end component and the seat stay junction, and a force is not imposed to the bending direction. Namely, when putting brake by the disc brake, “a force of bending” the seat stay and its junction is not generated. As a result, a force of putting brake can be efficiently received by the frame, it becomes possible to use a narrow or thin seat stay, and the bicycle can be made light. By using a narrow or thin seat stay, rigidity of the seat stay declines and comfort of riding the bicycle after setting up necessary components improves.

In the component according to the third aspect, preferably, a second′ female screw capable of fitting with a male screw for attaching a back rack is formed on the frame rear side of said seat stay attachment portion of said third′ protrusion. When using the rear fork end component formed with the second′ female screw, a bicycle frame capable of attaching a back rack on the frame rear portion and a bicycle having the frame can be provided. By arranging the second′ female screw at such a position, interference between the back rack at the rear portion and the disc brake caliper can be effectively prevented when attaching the back rack to the rear portion of the bicycle.

According to the present invention, a rear fork end component of a bicycle frame not requiring attachment of an end clasp, a bicycle frame having the component and a bicycle having the frame can be provided.

### BRIEF DESCRIPTION OF DRAWINGS

These and other objects and features of the present invention will become clearer from the following description of the preferred embodiments given with reference to the attached drawings, in which:

FIG. 1 is a front view of a bicycle according to an embodiment of the present invention;

FIG. 2 is a front view of a key part on the rear derailleur side of the bicycle in FIG. 1;

FIG. 3 is a front view of a rear fork end component 34a in FIG. 2;

FIG. 4 is a front view of a key part on the opposite side of the rear derailleur side of the bicycle in FIG. 1;

FIG. 5 is a front view of a rear fork end component 34b in FIG. 4;

FIG. 6 is a perspective view of both of the rear fork end components 34a and 34b in FIG. 3 and FIG. 5;

FIG. 7 is a front view showing a state on the rear derailleur side when a rear wheel is removed;

FIG. 8 is a view of a process of putting the bicycle in a wheeling bag;

FIG. 9A is a front view of the rear fork end component 34a in FIG. 2;

FIG. 9B is a backside view of FIG. 9A;

FIG. 9C is a plan view of FIG. 9A;

FIG. 9D is a bottom view of FIG. 9A;

FIG. 9E is a right side view of FIG. 9A;

FIG. 9F is a left side view of FIG. 9A;

FIG. 10A is a front view of the rear fork end component 34b in FIG. 4;

FIG. 10B is a backside view of FIG. 10A;

FIG. 10C is a plan view of FIG. 10A;

FIG. 10D is a bottom view of FIG. 10A;

FIG. 10E is a right side view of FIG. 10A; and

FIG. 10F is a left side view of FIG. 10A.

### DESCRIPTION OF THE PREFERRED EMBODIMENT

Below, the present invention will be explained based on embodiments shown in drawings.

In the present embodiment, an MTB type bicycle will be explained as an example.

Bicycle

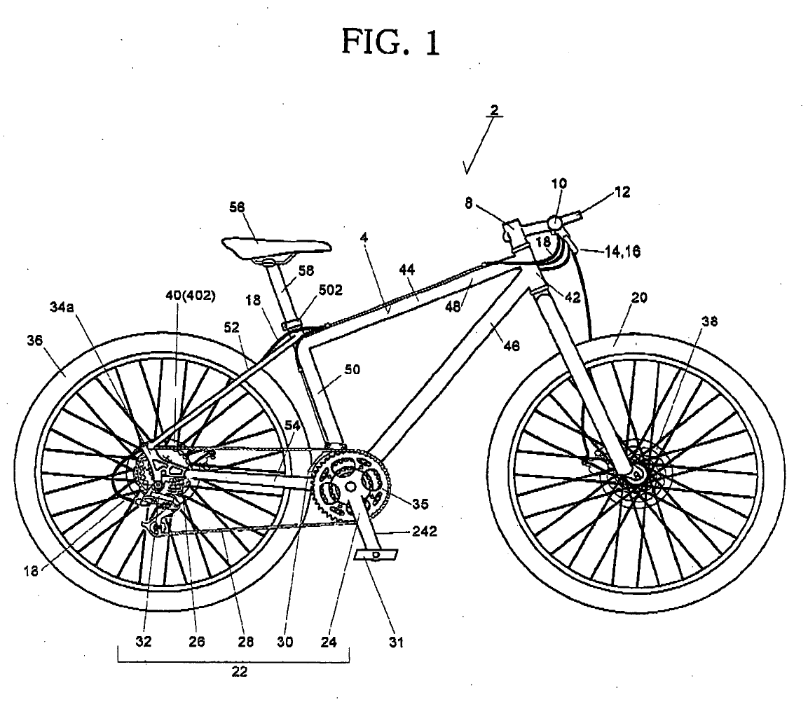

As shown in FIG. 1, the MTB type bicycle 2 according to the present invention comprises a frame 4 as skeleton of the body.

A front fork 6 is supported rotatably on the front portion of the frame 4. The front fork 6 may be a type having a suspension system in a lower portion outer case or a rigid type without it.

A handle stem 8 is fixed to an upper portion of the front fork 6. On the front portion of the handle stem 8 is fixed a handle bar 10 extending to the right and the left (in the direction of the paper surface in FIG. 1). On both ends of the handle bar 10 are attached with end bars 12, and inner sides the respective end bars 12 are attached with rubber or sponge grip (not shown). Inner sides of the pair of grips (not shown) are attached with a pair of brake bars 14 and a pair of shift levers 16. One of the shift levers 16 is for a gearshift operation of the front derailleur 30 and the other is for a gearshift operation on the rear derailleur 32. The gearshift operation is generally performed by loosening or drawing in gearshift wires (not shown) connecting the shift levers 16 and the derailleurs 30 and 32, respectively. At a bent portion of the gearshift wire (not shown), an outer tube 18 is used for guiding the gearshift wire by covering it.

A front wheel 20 is detachably attached at the lower end of the front fork 6.

At a lower portion from the center to the rear portion of the frame 4, a drive 22 for converting a pedaling force to a driving force is provided. The drive 22 comprises a gear crank portion 24 provided to a hanger portion (not shown) of the frame 4, a sprocket 26 attached to a free hub (not shown) of the rear wheel 36, a chain 28 bridged between the gear crank portion 24 and the sprocket 26, a front derailleur 30 for shifting a change-speed gear stage, and a rear derailleur 32.

The gear crank portion 24 comprises a right gear crank 242 attached with a pedal 31 at its end and a left crank (not shown). The right gear crank 242 and the left crank (not shown) are connected by a crank axis (not shown). The crank axis is supported in a freely rotatable way by a bottom bracket (BB: not shown) provided inside the hanger portion (not shown). The right gear crank 242 is attached with, for example, two or three gear plates 35 having different number of cogs arranged in the crank axis direction (the direction of the paper surface in FIG. 1). The sprocket 26 is attached with, for example, eight or nine small gears having different number of cogs arranged in the direction of the hub axis of the rear wheel 36.

The front derailleur 30 is connected to one of the pair of shift levers 16 attached to a handle bar 10 via an inner wire (not shown).

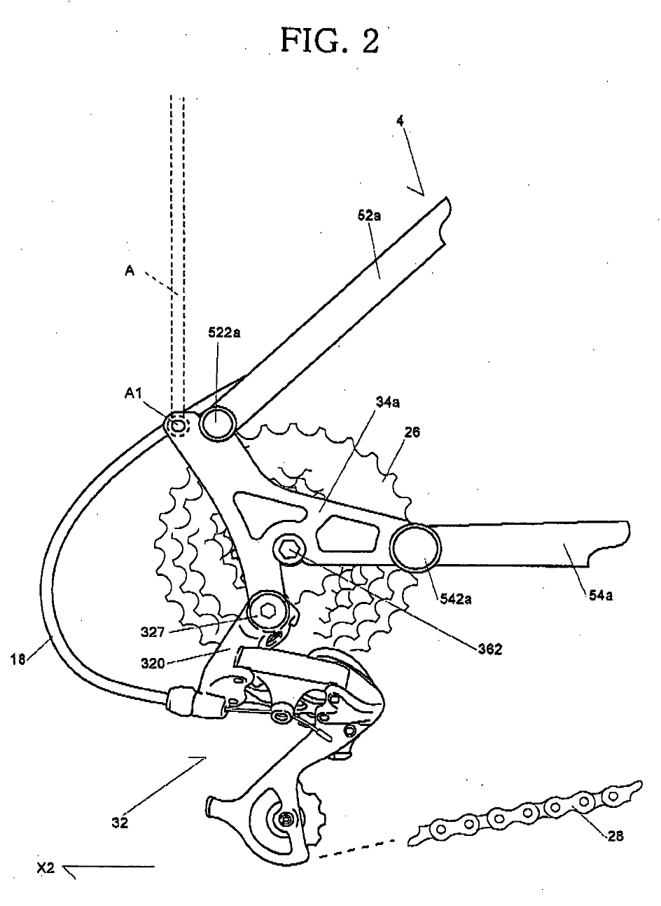

As shown in FIG. 1 and FIG. 2, the rear derailleur 32 is rotatably fixed to a first rear fork end component 34a with a screw 327 via the adapter portion 320 and is biased by a pivot spring (not shown) to be rotated in the direction of the rear side of the frame 4 (in the X2 direction in FIG. 2) about the screw 327.

In the present embodiment, as shown in FIG. 2, the gearshift wire (not shown) from the shift lever 16 (refer to FIG. 1) passes inside the right seat stay 52a to be connected to the rear derailleur 32 through an outer tube 18 for guiding the gearshift wire by covering it. Consequently, the gearshift wire is prevented from protruding to outside in the direction of a width of the frame 4. As a result, the possibility that branches and grasses, etc. get tangled in the gearshift wire during cycling decreases, and a gearshift trouble is suppressed.

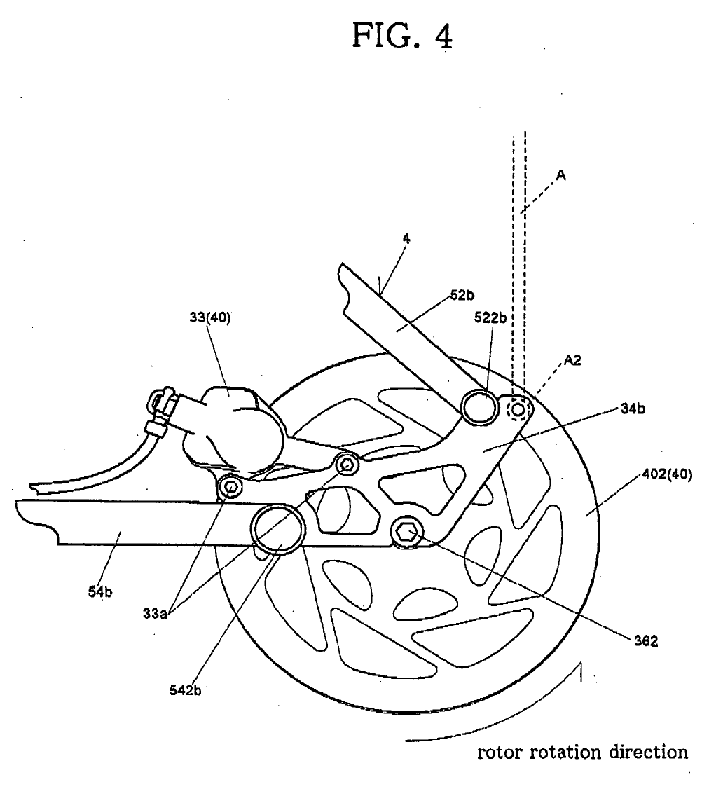

As shown in FIG. 1, the rear wheel 36 is detachably attached to the rear portion of the frame 4. Also, in the present embodiment, a front brake device 38 for the front wheel 20 is provided near the lower portion of the front fork 6. As shown in FIG. 1 and FIG. 4, a rear brake device 40 for the rear wheel 36 is provided near the rear portion of the frame 4.

Frame

The frame 4 has a diamond shape composed of a front triangle and a rear triangle, in the present embodiment. The frame 4 comprises a head portion 42 inserted by a column portion of the front fork 6 for supporting it in a freely rotatable way around an oblique axis, a hanger portion (not shown) for supporting the crank axis (not shown) in a freely rotatable way, and a frame member 44 for connecting them. The components are composed of a pipe made by various materials, such as aluminum, chrome-molybdenum steel, a titanium alloy and a carbon material.

The frame member 44 comprises a down tube 46, a top tube 48, a seat tube 50, a seat stay 52 and a chain stay 54.

The down tube 46 extends from the head portion 42 and slopes down to the posterior direction, and the hanger portion (not shown) is arranged at the rear end of the down tube 46. The top tube 48 extends from the head portion 42 to the posterior direction above the down tube 46.

The seat tube 50 connects the rear end of the top tube 48 and the rear end of the down tube 46, and its upper end portion is formed with a saddle fixing portion 502 for adjustably fixing a vertical position of the seat post 58, which is further fixed with the saddle 56 at its upper end. Near the lower end of the seat tube 50 is cramped by the front derailleur 30.

In the present embodiment, the seat stay 52 is biforked and extends from the rear end of the top tube 48 to slope down in the posterior direction, and composed of a right seat stay 52a and a left seat stay 52b.

The chain stay 54 is biforked and extends from the hander portion (not shown) or nearby area to the posterior direction, and composed of a right chain stay 54a and a left chain stay 54b.

In the present embodiment, on the rear derailleur 32 side shown in FIG. 1 and IFG. 2, the rear ends of the right seat stay 52a and the right chain stay 54a are connected to a first rear fork end component 34a via pipe-shaped adapters 522a and 542a, respectively as shown in FIG. 2. On the other side of the rear derailleur 32 shown in FIG. 4, as shown in FIG. 4, the rear ends of the left seat stay 52b and the left chain stay 54b are connected to a second rear fork end component 34b via pipe-shaped adapters 522b and 542b, respectively. Here, the pipe-shaped adapters 522a, 542a, 522b and 542b are provided for an easier operation of attaching the seat stays 52a and 52b and the chain stays 54a and 54b to the end components 34a and 34b and are not always necessary. Also, when the adopters are provided, angles of attaching the seat stays 52a and 52b and the chain stays 54a and 54b can be easily adjusted, so that there is an advantage that a suitable attachment in accordance with a frame size becomes possible. Note that the seat stays 52a and 52b and the chain stays 54a and 54b may be directly attached to the rear fork and components 34a and 34b without the pipe-shaped adapters 522a, 542a, 522b and 542b in the present invention.

First Rear Fork End Component

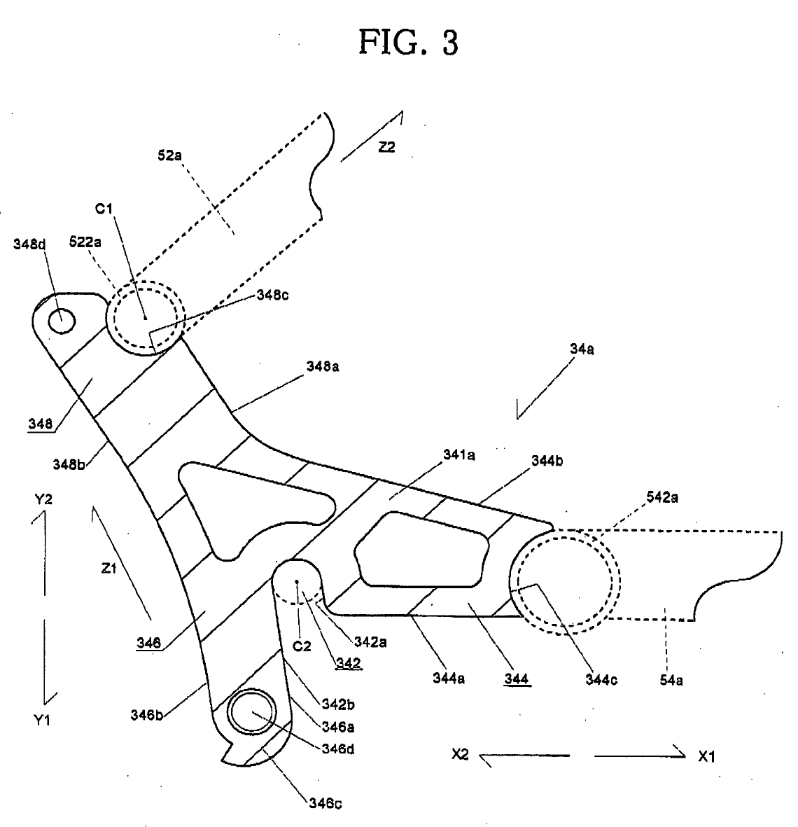

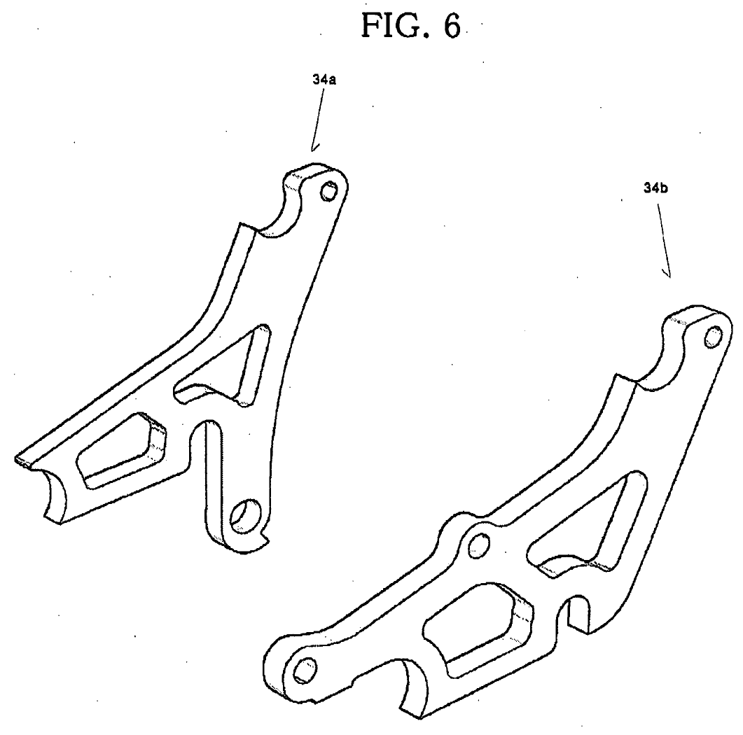

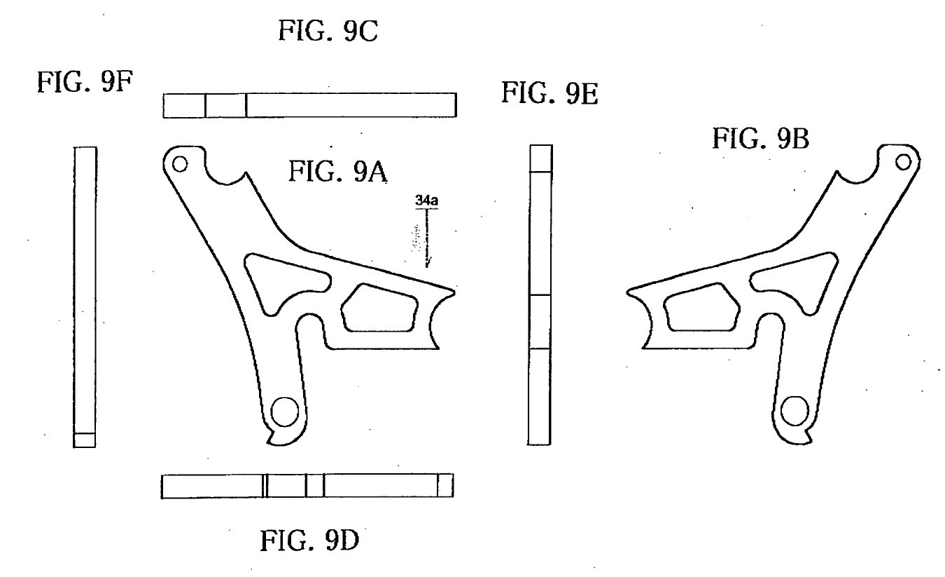

As shown in FIG. 2, FIG. 3, FIG. 6 and FIG. 9A to FIG. 9F, the first rear fork and component 34a is composed of a solid object. The solid object may be obtained by machining, casting or forging a metal plate or a metal block of aluminum, etc.

The first rear fork end component 34a comprises a component body 341a.

The component body 341a is formed a first concave portion 342 as a rear wheel axle supporting portion. The first concave portion 342 is for supporting the axle 362 (refer to FIG. 2) of the rear wheel 36 (refer to FIG. 1) to be inserted from below the frame to the Y2 direction in FIG. 3 in a freely detachable way and composed of an inner wall surface 342a on the frame front side (in the X1 direction in FIG. 3) and an inner wall surface 342b on the frame rear side (in the X2 direction in FIG. 3) connected to the inner wall surface 342a near the center.

The first protrusion 344 is formed to protrude from the frame front side inner wall surface 342a of the first concave portion 342 to the frame front side. The first protrusion 344 is composed of an outer surface 344a on the frame lower side (in the direction of Y1 in FIG. 3) and an outer surface 344b on the frame upper side (in the direction of Y2 in FIG. 3) connecting to each other via a second concave portion 344c formed at its end.

In the present embodiment, the second concave portion 344c functions as a chain stay attachment portion for allowing a rear end of the right chain stay 54a of the frame 4 shown in FIG. 2 to be attached and is actually attached with the rear end of the right chain stay 54a via the pipe-shaped adapter 542a.

The second protrusion 346 is formed to protrude from the frame rear side inner wall surface 342b of the first concave portion 342 to the lower side of the frame. The second protrusion 346 is composed of the frame front side outer surface 346a and the frame rear side outer surface 346b connected via the protrusion 346c formed at its end. A first female screw 346d is formed near the protrusion 346c, to which a male screw 327 of the rear derailleur 32 shown in FIG. 2 can be screwed.

A third protrusion 348 is formed to protrude from the frame upper side outer surface 344b of the first protrusion 344 and the frame rear side outer surface 346b of the second protrusion 346 to the frame upper side and to the frame rear side. The third protrusion 348 is composed of the frame front side outer surface 348a and the frame rear side outer surface 348b connected via a third concave portion 348c formed near the frame front side of its end.

In the present embodiment, the third concave portion 348c functions as a seat stay attachment portion for allowing the rear end of the right seat stay 52a of the frame 4 shown in FIG. 2 to be attached and is actually attached with the rear end of the right seat stay 52a via the pipe-shaped adapter 522a.

In the present embodiment, the third concave portion 348c is arranged to be offset from the first concave portion 342 to the frame upper side and the frame rear side, Accordingly, in the present embodiment, an attachment position of the right seat stay 52a is offset from the axle 362 (refer to FIG. 2) of the rear wheel 36 (refer to FIG. 1) to the upper side and rear side of the frame 4. Therefore, not only being free from the burden of attaching the end clasp to the end portion when conveying the bicycle, but the riding comfort improves and a gearshift trouble hardly arises.

In the present embodiment, for example, when looking a center position C1 of a circle assumed to have an outer diameter of the inner wall surface of the third concave portion 348c from a center position C2 of a circle assumed to have an outer diameter of an inner wall surface of the first concave portion 342, the above offset amount is preferably 40 to 70 mm (more preferably, 50 to 60 mm) in the direction of the frame upper side and preferably 20 to 40 mm (more preferably, 25 to 35 mm) in the direction of the frame rear side. Note that the value can be freely changed.

In the present embodiment, the third concave portion 348c is arranged at a position where the protruding direction (the direction of Z1 in FIG. 3) of the third protrusion 348 and the extending direction (the direction of Z2 in FIG. 3) of the seat stay 52a are at approximately right angles to each other. As a result, it becomes possible to use a narrow and thin seat stay 52a, which contributes to making the bicycle 2 lighter and comfortable to ride.

In the present embodiment, the second female screw 348d to be fitted with the male screw A1 for attaching a back rack A shown in FIG. 2 is formed on the rear side of the third concave portion 348c of the third protrusion 348. Consequently, the back rack A (refer to FIG. 2) is easily attached to the rear portion of the bicycle.

Note that, in the present embodiment, based on the assumption of securing strength of the end portion of the frame 4, around the center of the first protrusion 344 and around the center of the third protrusion 348 are hollowed for making it lighter.

Second Rear Fork End Component

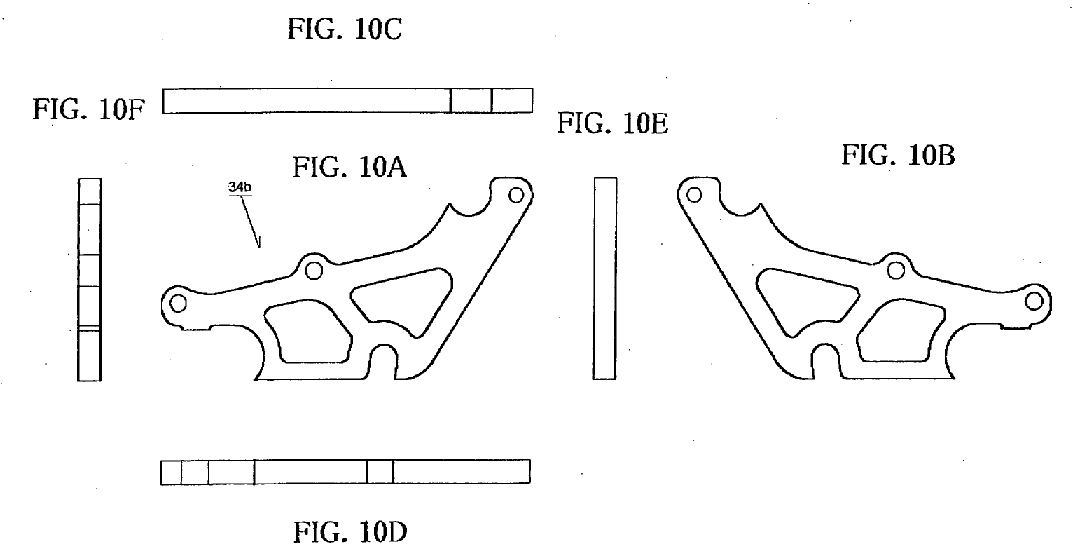

As shown in FIG. 4 to FIG. 6 and FIG. 10A to FIG. 10F, in the same way as the above first rear fork end component 34a, the second rear fork end component 34b is composed of a solid object,

The second rear fork end component 34b has a component body 341b.

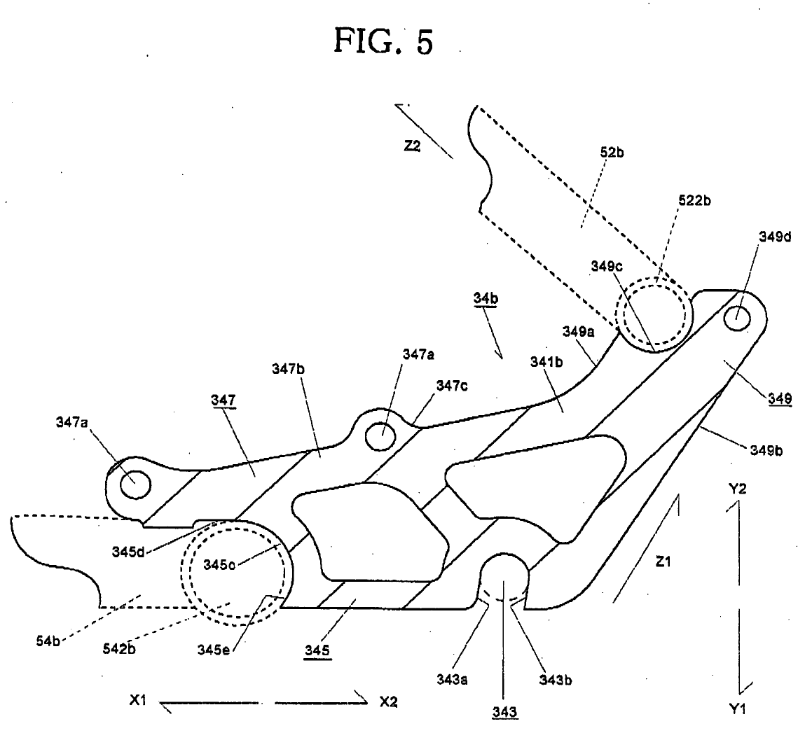

The component body 341b is formed with a first′ concave portion 343 as a rear wheel axle supporting portion. The first′ concave portion 343 in for supporting the axle 362 (refer to FIG. 4) of the rear wheel 36 (refer to FIG. 1) to be inserted from below the frame to the Y2 direction in FIG. 5 in a freely detachable way and composed of an inner wall surface 343a on the frame front side (in the X1 direction in FIG. 5) and an inner wall surface 343b on the frame rear side (in the X2 direction in FIG. 5) connected to the inner wall surface 343a near the center.

The first′ protrusion 345 is formed to protrude from the frame front side inner wall surface 343a of the first′ concave portion 343 to the frame front side. A second′ concave portion 345c is formed at the end of the first′ protrusion 345. The second′ concave portion 345c is composed of an inner surface 345d on the frame upper side (in the direction of Y2 in FIG. 5) and an inner wall surface 345e on the frame lower side (in the direction of Y1 in FIG. 5) connecting to the inner wall surface 345d near the center.

In the present embodiment, the second′ concave portion 345c functions as a chain stay attachment portion for allowing a rear end of the left chain stay 54b of the frame 4 shown in FIG. 4 to be attached and is actually attached with the rear end of the left chain stay 54b via the pipe-shaped adapter 542b.

The second′ protrusion 347 is formed to protrude from the frame upper side inner wall surface 345d of the second′ concave portion 345c to the frame front side and the frame upper side. The second′ protrusion 347 comprises a disc brake base 347b having a pair of through holes 347a and 347a satisfying the international standard (a through hole width of 51 mm) for attaching and fixing a disc brake caliper from the backside. The pair of through holes 347a and 347a of the disc brake base 347b are attached with clinch members 33a of the disc brake caliper 33 shown in FIG. 4 and fixed.

A third′ protrusion 349 is formed to protrude from the frame upper side outer surface 347c of the second′ protrusion 347 to the frame upper side and frame rear side. The third′ protrusion 349 is composed of the frame front side outer surface 349a and the frame rear side outer surface 349b connected via a third′ concave portion 349c formed near the frame front side of its end.

In the present embodiment, the third′ concave portion 349c functions as a seat stay attachment portion for allowing the rear end of the left seat stay 52b of the frame 4 shown in FIG. 4 to be attached and is actually attached with the rear end of the left seat stay 52b via the pipe-shaped adapter 522b.

In the present embodiment, a disc brake base 347b of the international standard is provided on the inner side of the end portion (on the side attached with the chain stay). Since the disc brake base 347b is formed on the sturdy chain stay side 54b, there is no need to furthermore weld a reinforcing plate or to make the seat stay thick, moreover, a howling noise made by putting brake can be suppressed. Also, the disc brake caliper 33 can be fit between the seat stay 52b and the chain stay 54b. As a result, the risk of damaging the caliper due to toppling, etc. is decreased.

Also, in the present embodiment, the third′ concave portion 349c is arranged to be offset from the first, concave portion 343 to the frame upper side and the frame rear side, the same effects as those in the case of the above first rear fork end component 34a are obtained.

In the present embodiment, an offset amount to the frame rear side may be the same as that in the above first rear fork end component 34a.

In the present embodiment, the third′ concave portion 349c is arranged at a position where the protruding direction (the direction of Z1 in FIG. 5) of the third′ protrusion 349 and the extending direction (the direction of Z1 in FIG. 5) of the seat stay 52b are at approximately right angles to each other. As a result, it becomes possible to use a narrow and thin seat stay 52b, which contributes to making the bicycle 2 lighter and comfortable to ride. Particularly, by arranging the third′ concave portion 349c as such, the frame can effectively receive a force at the time of putting brake and it becomes possible to use a narrow and thin seat stay.

In the present embodiment, the second′ female screw 349d to be fitted with the male screw A2 for attaching the back rack A shown in FIG. 4 is formed on the rear side of the third′ concave portion 349c of the third′ protrusion 349. Consequently, the back rack A (refer to FIG. 4) is easily attached to the rear portion of the bicycle while suppressing interference with the disc brake caliper 33.

Note that, in the present embodiment, based on the assumption of securing strength of the and portion of the frame 4, around the center of the first′ protrusion 345 and around the center of the third′ protrusion 349 are hollowed for making it lighter.

Note that the reference number 402 in FIG. 4 indicates a disc brake rotor as a component of the rear brake device 40.

Example of Putting Bicycle 2 in Wheeling Bag

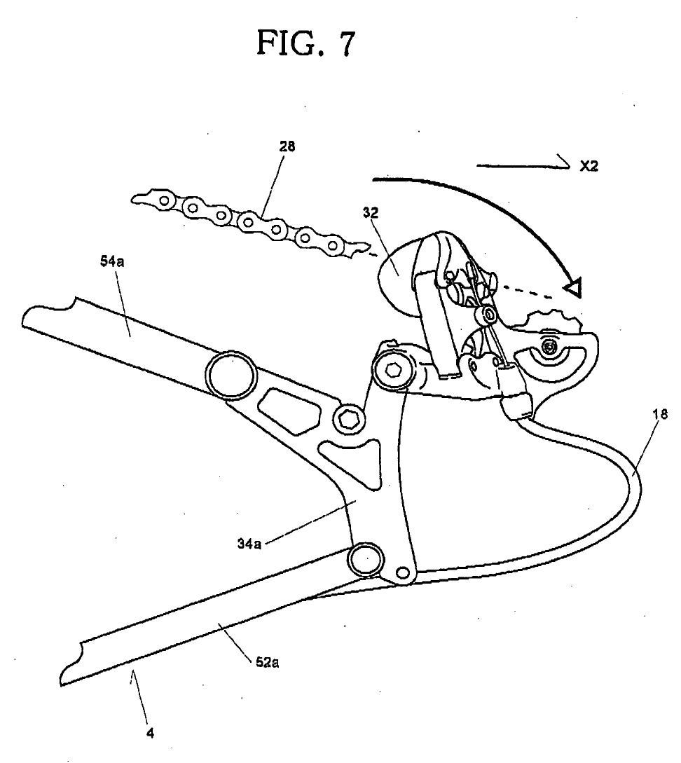

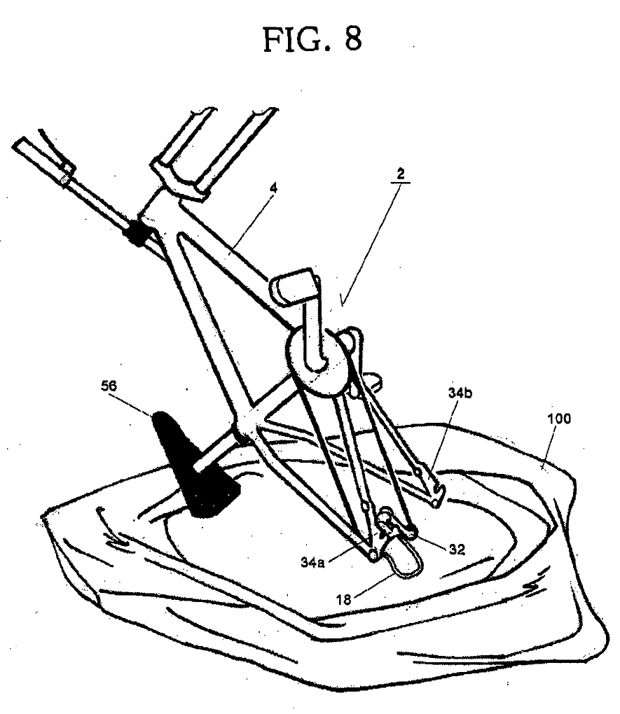

Next, with reference to FIG. 1, FIG. 7 and FIG. 8, an example of putting the bicycle 2 in the wheeling bag 100 in a state that the front and rear wheels 20 and 36 are removed from the frame 4 will be explained.

First, the rear derailleur 32 is shifted to the minimum gear (on the top side) as preparation. This is for an easier attachment of the rear wheel 36 to the rear fork end components 34a and 34b when assembling the bicycle 2 later on.

Next, the front wheel 20 is removed. The bicycle 2 is placed up side down on the ground as preparation of removing the front wheel 20. Then, a quick release lever (not shown) for holding the front wheel 20 is released, a nut on the opposite side of the lever is turned to the releasing direction in accordance with need, and the front wheel 20 is pulled up to be removed.

Next, the rear wheel 36 is removed. To remove the rear wheel 36, after releasing the quick release lever (not shown) holding the rear wheel 36 and turning the nut on the opposite side of the lever to the releasing direction in accordance with need, the rear wheel 36 is pulled up to be removed while pulling the rear derailleur 32 to the frame rear side. At this time, the rear derailleur 32 rotates to the rear side of the frame 4 (in the direction of X2 in FIG. 7) as shown in FIG. 7 about the fixed portion of the screw 327 due to an action of the pivot spring (not shown) explained above and stops.

Next, as shown in FIG. 8, the frame 4 after removing the front wheel 20 and the rear wheel 36 is put in the wheeling bag 100 without attaching any end clasp. Specifically, for example, the frame 4 is made stand by itself in a state that the saddle 56 and ends of the rear end fork components 34a and 34b face the ground at an approximately center portion of the wheeling bag 100 spread with its fastener fully unzipped. Next, after putting the front and rear wheels 20 and 36 removed from the frame 4 in the wheel storage pocket (not shown) provided inside the wheeling bag 100, the front and rear wheels 20 and 36 and, for example, the down tube 46 of the frame 4 are fixed with a belt (not shown). Then, the fastener is zipped, and the entire bag is fastened with two outer fastening belts (not shown), so as not to mess the contents while being conveyed. After that, a shoulder belt is attached outside the bag, so that the bag can be portable.

In the present embodiment, since special rear end fork components 34a and 34b are attached, damages on the rear derailleur 32 and a trouble of bending the gearshift wire do not arise and the bicycle 2 can be made stably stand by itself even when an end clasp is not attached to the end portion after removing the rear wheel 36. As a result, there is an advantage that it becomes not necessary to attach the end clasp to the end portion, which has been considered troublesome, when conveying the bicycle.

The embodiments of the present invention have been explained above, but the present invention is not at all limited to the embodiments and may be naturally embodied in various ways within a range of the scope of the present invention.

For example, the present invention is not only applied to a so-called hardtail as in the present embodiment, but may be applied to a type having a suspension system on the frame rear portion (a so-called full suspension type). In this case, the seat stay can be away from the rear end of the top tube and, for example, formed to be biforked and extends from a link member to slope down to the rear side.

1. A rear fork end component of a bicycle frame, comprising, when assuming a bicycle frame produced by using the end component:
a component body;
a rear wheel axle supporting portion formed on the component body, for detachably supporting the axle of the rear wheel to be inserted from below the frame; and
a seat stay attachment portion for allowing a rear end of a seat stay to be attached;
wherein said seat stay attachment portion is arranged to be offset to the upper side of the frame and the rear side of the frame from said rear wheel axle supporting portion.

2. A rear fork end component on the rear derailleur side of a bicycle frame comprising, when assuming a bicycle frame produced by using the end component:
a component body;
a rear wheel axle supporting portion formed on the component body, for detachably supporting the axle of the rear wheel to be inserted from below the frame;
a first protrusion formed to protrude from a frame front side inner wall surface of the rear wheel axle supporting portion to the frame front side, having at its end a chain stay attachment portion for allowing a rear end of a chain stay to be attached;
a second protrusion formed to protrude from a frame rear side inner wall surface of said rear wheel axle supporting portion to the frame lower side, having near its end a first female screw capable of fitting with a male screw for attaching the rear derailleur; and
a third protrusion formed to protrude from a frame upper side outer surface of said first protrusion and a frame rear side outer surface of said second protrusion to the frame upper side and the frame rear side, having near the frame front side of its end a seat stay attachment portion for allowing a rear end of the seat stay to be attached;
wherein said seat stay attachment portion is arranged to be offset to the frame upper side and the frame rear side from said rear wheel axle supporting portion.

3. The rear fork end component as set forth in claim 2, wherein said seat stay attachment portion is arranged at a position where the protruding direction of said third protrusion and the extending direction of the seat stay are at an approximately right angle to each other.

4. The rear fork end component as set forth in claim 2 or 3, wherein a second female screw capable of fitting with a male screw for attaching a back rack is formed on the frame rear side of said seat stay attachment portion of said third protrusion.

5. A rear fork end component on the opposite side of the rear derailleur of the bicycle frame comprising, when assuming a bicycle frame produced by using the end component:
a component body;
a rear wheel axle supporting portion formed on the component body, for detachably supporting the axle of the rear wheel to be inserted from below the frame;
a first′ protrusion formed to protrude from the frame front side inner wall of the rear wheel axle supporting portion to the frame front side, having at its end a chain stay attachment portion for allowing a rear end of a chain stay to attach;
a second′ protrusion formed to protrude from the frame upper side inner wall surface of said first′ protrusion to the frame front side and the frame upper side, having a pair of through holes for fixing a disc brake caliper from a back surface; and
a third′ protrusion formed to protrude from a frame upper side outer surface of the second′ protrusion to the frame upper side and frame rear side, having near the frame front side of its end a seat stay attachment portion for allowing a rear end of a seat stay to be attached;
wherein said seat stay attachment portion is arranged to be offset to the frame upper side and frame rear side from said rear wheel axle supporting portion.

6. The rear fork end component as set forth in claim 5, wherein said pair of through holes are arranged to satisfy the international standard.

7. The rear fork end component as set forth in claim 5 or 6, wherein said seat stay attachment portion is arranged at a position where the protruding direction of said third′ protrusion and the extending direction of the seat stay are at an approximately right angle to each other.

8. The rear fork end component as set forth in claim 5 or 6, wherein a second′ female screw capable of fitting with a male screw for attaching a back rack is formed on the frame rear side of said seat stay attachment portion of said third′ protrusion.

9. A bicycle frame having the rear fork end component as set forth in claim 1.

10. A bicycle frame having the rear fork end component as set forth in claim 2.

11. A bicycle frame having the rear fork end component as set forth in claim 5.

12. A bicycle having the bicycle frame as set forth in claim 9.

13. A bicycle having the bicycle frame as set forth in claim 10.

14. A bicycle having the bicycle frame as met forth in claim 11.
